(19) United States
(12) Patent Application Publication
(10) Pub. No.: US 2011/0078041 A1
(43) Pub. Date: Mar. 31, 2011

(54) Method, System, and Computer Program for Parsing, Compiling and Disseminating Digital Media

(76) Inventor: Ian Barker, Toronto (CA)

(21) Appl. No.: 12/994,800

(22) PCT Filed: May 27, 2009
(86) PCT No.: PCT/CA2009/000708

§ 371 Date: Nov. 26, 2010

Related U.S. Application Data
(60) Provisional application No. 61/056,200, filed on May 27, 2008.

(51) Int. Cl. G06Q 30/00; G06F 17/30

(52) U.S. Cl. 705/26.25; 707/736; 707/E17.044

(57) ABSTRACT

The present invention relates to the dissemination of digital media. In one aspect of the present invention, a method for disseminating content is provided, the method comprising: one or more rights holders providing one or more items of content to a database; the rights holders directing parsing of the content into content elements; the rights holders associating pricing conditions and dissemination conditions with the content; one or more editors assembling the content elements into one or more compilations; and one or more consumers purchasing one or more of the compilations.

### PRIORITY CLAIMED

This application claims priority from U.S. Provisional Patent Application No. 61/056,200 filed May 27, 2008.

### FIELD OF THE INVENTION

The present invention relates to the dissemination of digital media. More specifically, the present invention relates to a method, system, and computer program enabling content rights holders to disseminate elements of such content to consumers through intermediaries that assemble the elements into new works.

### BACKGROUND OF THE INVENTION

There is demand is certain markets—education, corporate training and development, professional development, research, and among subject matter enthusiasts—for edited publications containing content from multiple rights-holders. An example comes from higher education, where professors are forced to compromise the content and quality of their courses because they are obliged to utilize generic printed or electronic texts (due to reasons that include lack of choice, and the expense to students of mandating too many sources). Alternatives, like printed coursepacks, are time-consuming to produce, unwieldy, static, not in keeping with the widespread educational trend toward “experiential learning”. The intent and benefits of experiential learning can be intuited, but the idea is that providing students with a more engaging, interactive and dynamic environment leads to an enhanced learning experience. Furthermore, coursepacks and other print-based solutions fail to take advantage of the inherent features and benefits of online and mobile access and usage of digital content. Existing patents fail to take advantage of the combined benefits of aggregation, data parsing (e.g. extracting a chapter from a book, a page from a chapter, a data set from research, a media file from a repository), editing (e.g. organizing, amending, recombining, embedding etc.), interactivity, collaboration and publishing. They also fail to account for other required features and services of aggregation services including, but not limited to specialized billing, royalty management, and tracking and reporting tools.

Furthermore, publishers recognize the need to offer more—and more robust—digital media products to different end-user markets (e.g. higher education publishing, trade publishing). They currently offer digital media products that allow editors (such as professors) to mix and match content from within the publisher's own collection. But the demands of the aforementioned markets outstrip this offering. Editors want to be able to select extracts (chapters, pages, images, data sets, media files etc.) from a variety of sources, include their own content, and edit the aggregated information into, in the example of the education market, a meaningful, useful, “liquid textbook” for each course the educator teaches. End users (e.g. students, subject matter enthusiasts like history buffs) want access to relevant, targeted, deep, trustworthy and cost-effective content, and to be able to discover more and better resources about a given topic. This may not always come in the form of a traditional book or film, and with technology advances, this is increasingly the case.

For example, the SafariU™ product does not offer users the ability to interact with an online digital media product. This misses trends toward adoption and utilization of online content, resulting in minimal interactivity. Content and collaborations created by intermediaries (in this case, professors and students) are not dealt with in this model. Online-only pricing and options for print outputs are also not dealt with in this model. Furthermore, the product is limited in that its proprietors are themselves publishers. They are not, therefore, a neutral aggregator and do not share the same objectives and methods of the aggregator: providing the best content to end users at the best prices. Thus, the product lacks the discipline of open, market-based, competitive pricing and free decision-making of purchasers.

Currently, individual publishers, regardless of their size, cannot aggregate multi-publisher content efficiently or extensively. This leaves publishers relying heavily upon selling their own content and titles, which they do in both print and digital form. They thus compete, expensively, in the development of web-based software products which extends their competition away from quality of content and into software development.

Digital “mash-up” systems are beginning to emerge but these are limited to digital production processes culminating in printed course-packs, which fail to leverage the inherent benefits and flexibility of online delivery.

By far the most common form of publishers' content sales is the traditional book, again in print or digital form. But generic books (and indeed other generic works like film, image repositories, presentation materials, research data and the like) may be resold or pirated, resulting in a very large used textbook (in the case of education) market from which rights holders generate little to no royalty or sales revenue.

Furthermore, current solutions offered by publishers are limited in that they are configured to only provide dissemination of digital versions of traditional content. What has not been achieved to date is a system that also provides a medium for dissemination of software provided by outside vendors. Customized content and customized applications lead to optimal communication outcomes. For example, in the context of dissemination of educational materials, intermediaries such as professors and students desire the ability to incorporate e-learning applications into their educational content. They therefore desire a system that disseminates both knowledge content and related e-learning applications.

What has not been disclosed to date is a system to overcome these issues.

U.S. Pat. No. 6,091,930 to J. Thomas Mortimer et al discloses a customizable interactive textbook. However, U.S. Pat. No. 6,091,930 does not accommodate multiple rights holders that may each specify pricing and dissemination information; does not accommodate updated versions of content; and does not include any digital rights management or copyright protection features.

U.S. Pat. No. 7,139,977 to Russell discloses a system and method for producing a virtual online book. U.S. Pat. No. 7,139,977 describes software that automatically parses book content and reassembles components of books based upon a search query. However, there is no description of accommodating multiple rights holders, that may each specify pricing and dissemination information; does not accommodate updated versions of content; and does not include any digital rights management or copyright protection features.

U.S. Pat. No. 7,240,067 to Timmons discloses a system and methodology for extraction and aggregation of data from dynamic content. This patent deals primarily with how to find and extract data from a variety of web sources. It is also an automated system, in the sense that a query generates an automatic set of results. U.S. Pat. No. 7,240,067 does not describe accommodating multiple rights holders, that may each specify pricing and dissemination information; does not accommodate updated versions of content; and does not include any digital rights management or copyright protection features.

U.S. Pat. No. 7,117,200 to Amir et al. discloses a method for synthesizing information-bearing content from multiple channels. This patent addresses some of the mechanics of acquiring content from third parties but does not describe how rights holders may price their content, and otherwise manage it; how a final product is priced, how it is paid for, nor how it may be accessed; and providing updated versions of content.

Therefore, what is required is a content distribution means wherein a plurality of rights holders may contribute content, specifying associated pricing and dissemination restrictions, and wherein editors may selectively include the content or elements thereof into a compilation for dissemination to consumers. What is also required is a means by which a rights holder may provide updated content that may automatically be disseminated to the editors and consumers that have dealt with the incumbent content. What is further required is a system, method and enabling business models to allow rights-holders to meet their organizational objectives (e.g. dissemination and sharing, profits and market penetration) while also allowing editors and end users to create and consume publications that feature greater variety, flexibility, content and applications, and that are designed to be compatible with digital access and consumption.

In terms of editors, what is required is a system and method that enables an editor (e.g. a professor) to create unique digital publications using the combined strengths of aggregation, parsing, editing, interactivity, collaboration and publishing in such a way that there is no competing generic print or digital work, and therefore rights-holders can be assured of not losing sales to the used publication market. Editors would also benefit from this model because they can completely customize content to meet their pedagogical objectives. Customized liquid texts could then be made available under a variety of commercial models. In the education example, students, or the institution they attend, might pay for access, benefiting from a more contemporary, engaging, interactive and experiential learning experience. In more consumer-oriented markets, access to content might follow an advertising-supported model. In any case, end users benefit from access to customized, experiential, interactive and targeted content, with the added benefit of choosing and paying for online or online-plus-print access.

### SUMMARY OF THE INVENTION

In one aspect of the present invention, a method for disseminating content is provided, the method comprising: (a) one or more rights holders providing one or more items of content to a database; (b) the rights holders directing parsing of the content into content elements; (c) the rights holders associating pricing conditions and dissemination conditions with the content; (d) one or more editors assembling the content elements into one or more compilations; and (e) one or more consumers purchasing one or more of the compilations.

In another aspect of the present invention, a system for disseminating content is provided, the system comprising: (a) a database operable to store one or more items of content provided by one or more rights holders; (b) a means for parsing the content into content elements as specified by the rights holders; (c) a means for associating pricing conditions and dissemination conditions with each content element; (d) a means for assembling compilations of the content elements by editors; and (e) a means for providing the content elements to consumers.

In a further aspect of the present invention, a computer program product for disseminating content is provided, the computer program product comprising: (a) a computer readable medium bearing software instructions; and (b) the software instructions for enabling the computer to perform predetermined operations, the predetermined operations including the steps of: (i) one or more rights holders providing content to a database; (ii) the rights holders directing parsing of the content into content elements; (iii) the rights holders setting dissemination and pricing conditions; (iv) one or more editors assembling content elements into one or more compilations; and (v) one or more consumers purchasing one or more of the compilations.

### BRIEF DESCRIPTION OF THE DRAWINGS

FIG. 1 illustrates one aspect of the system of the present invention.

FIG. 2 illustrates the process of content relation and compilation.

FIG. 3 illustrates one aspect of the present invention whereby a secure authentication form is provided for granting access to the rights holder utility

FIG. 4 illustrates one aspect of the present invention whereby a secure online form is provided for depositing content to the back end of the system

FIG. 5 illustrates one aspect of the present invention whereby a form is provided for specifying the types and degrees of parsing of each of a plurality of works.

FIG. 6 illustrates one aspect of the present invention whereby a form is provided for specifying prices for each of a plurality of element types and each of plurality of works.

FIG. 7 illustrates one aspect of the present invention whereby a form is provided for specifying dissemination conditions, which may include regional conditions, for each of a plurality of works, and the portions of works among which conditions are specified.

FIG. 8 illustrates another aspect of the present invention whereby a form is provided for specifying dissemination conditions, which may include regional conditions, for each of a plurality of works, and the portions of works among which conditions are specified., further to that illustrated in FIG. 7.

FIG. 9 further illustrates a form providing dissemination conditions being specified based on consumer types, such that a rights holder may limit the types of consumers that could access the works based on one or more particular class levels.

FIG. 10 illustrates one aspect of the present invention whereby a web page is provided such that an unauthenticated or unregistered user to view the rights holder utility.

FIG. 11 illustrates a home page accessible within the editor utility.

FIG. 12 illustrates one aspect of the present invention whereby a web page is provided for searching the database.

FIG. 13 illustrates one aspect of the present invention whereby a web page is provided for retrieving and examining content returned from the editor's search previously illustrated in FIG. 12.

FIG. 14 illustrates one aspect of the present invention whereby a web page is provided for allowing an editor to select extracts from available works for compilation to a liquid work.

FIG. 15 illustrates the organization of content.

FIG. 16 illustrates a log in screen for a consumer, which may accept an ID and password combination to provide access to the consumer utility.

FIG. 17 illustrates one aspect of the present invention whereby a welcome page is provided that is operable to display works which the consumer has previously selected.

FIG. 18 illustrates a search utility to search for works or elements of works based on various criteria, such as media, author, keywords, topics, or titles.

FIG. 19 illustrates one aspect of the present invention whereby search results and associated snippets of content are displayed to a consumer.

### DETAILED DESCRIPTION

The present invention is best understood as a system and method for acquiring, assembling and publishing digital media content from multiple sources into new digital media publications. An example is a “liquid textbook”, in which an educator assembles customized digital textbooks for each course they teach from the entirety, or extracts, of other books, publications, audio-visual files, research, data sets, image repositories, e-learning applications and the like, including the educator's own works.

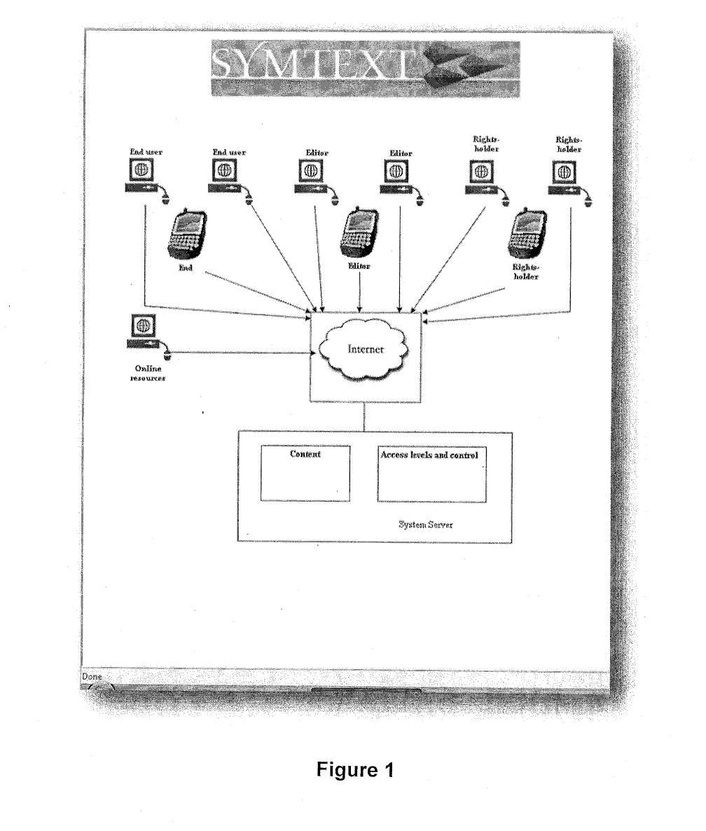

FIG. 1 illustrates one aspect of the system of the present invention. In one aspect of the present invention, an online environment is provided wherein (1) rights-holders (e.g. commercial publishers, academic presses, professors, libraries, out of copyright works, online collections, digitized museum collections, news media companies, individuals etc.) contribute digital media content (e.g. text, image, graphical, data, presentation, audio-visual, etc.) and e-learning applications to the system; (2) rights holders dynamically assign content distribution rules to specific digital media content and e-learning applications, including sub-sections of individual works; (3) editors assemble digital media content and e-learning applications from multiple sources to create a digital media compilation, (4) the digital media compilation and e-learning applications are exploited in conformity with distribution rules and business rules; (5) online and offline access to these compilations is provided according to distribution and business rules; (6) rights holders are compensated through royalties, content sales, advertising models and/or other revenue generating business models, and (7) rights holders and editors are provided with reporting and decision-making tools to help achieve business and/or organizational objectives relating to use of the system.

The system of the present invention enables publishers of content and intermediaries to disseminate that content in multiple jurisdictions. Thus publishers are given an opportunity to enter multiple vertical markets, requiring only the presence of a viable market (content suppliers, intermediaries and content consumers) and minimal incremental capital expenditure to gain revenues.

### Overview

The present invention, in one aspect thereof, teaches a system, method, and computer program operable to enable persons (herein referred to as “editors” or in some cases “compilers”), such as professors, teachers, assistants, tutors, corporate trainers, librarians) or other subject matter enthusiasts, to create digital compilations comprising one or more literary, artistic, musical, photographical, or other works comprised of content and applications from multiple rights holders (e.g. commercial publishers). It should be understood that any person creating one or more compilations of two or more works is an “editor” or “compiler”. Such compilations are herein referred to as “liquid” publications. The terms “publications” and “works” are used interchangeably herein.

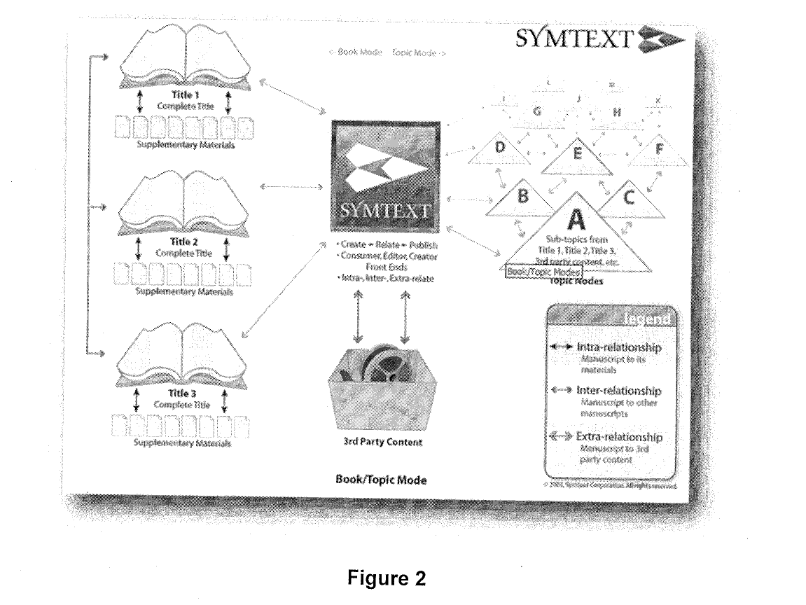

FIG. 2 illustrates the process of content relation and compilation. Building upon the concepts of aggregation, data parsing, editing, interactivity, collaboration and publishing, the present invention enables parties such as content creators and distributors to streamline the content creation, editing, publishing and selling process by:
providing a method for rights holders to offer content or applications, including sub-sections, chunks, or clips of the content or applications, that they may wish to share, sell, license, or otherwise exploit;
providing intermediaries such as editors or professors, means to search, retrieve, relate, edit, collaborate, share, and publish carefully crafted digital, multi-source works plus embed their own intellectual property into the works; and
providing users such as consumers, students, or subject matter enthusiasts a facility to access and pay for complete original works (e.g. book or film) and/or liquid publications comprised of edited extracts from multiple sources on subjects that interest them or subjects they must learn in accordance with rights-holders' and/or intermediaries' business and organizational objectives.

Collectively, these three steps may:
1. Enable a person to create new publications, being either original new publications or new publications formed from extracts of existing publications.
2. Enable a person to relate publications together in any or all of three ways:
   a. “Intra-relate” a publication to its various elements. For example, in the case of a literary work, this may include but is not limited to relating a title to its chapters, a chapter to its pages and paragraphs, a title to its digital learning objects, a title to its updates, a title to its “extras” (e.g. materials not published as part of a traditional publication).
   b. “Inter-relate” publications together from the same rights-holder. For example, in the case of a plurality of literary works, this may include but is not limited to relating chapters, paragraphs, pages, audio-visual content and the like from one of the plurality of works to another of the plurality of works. Elements (such as chapters, paragraphs, etc.) may be related to other types of elements in the other works. For example, a chapter in work A may be related to content in work B, and so on.
   c. “Extra-relate” publications together from a multitude of rights-holders. For example, in the case of a plurality of literary work, this may include but is not limited to relating chapters, paragraphs, pages, audio-visual content and the like from one of the plurality of works to another of the plurality of works. Elements (such as chapters, paragraphs, etc.) may be related to other types of elements in the other works. For example, a chapter in work A may be related to content in work B, and so on.
It should be noted that different types of works may be related. For example, a literary work or portions thereof may be related to an artistic work or portions thereof.
3. Enable the publishing of various sorts of database-driven, dynamic, liquid publications including but not limited to subject-based web-products (e.g. an anthology, compendium or wiki, or a consumer-oriented subscription or ad supported website); customized digital publications (e.g. liquid textbook); books; journals; blogs; forums; compilations; repositories and other digital works. Access to these publications may be provided on the Internet, on various devices including wireless devices, and offline via print-on-demand services and offline digital devices.

The present invention, in another aspect thereof, may provide a means for users to navigate from original works to liquid publications, and from liquid publications to original works in accordance with rights holders' business and organizational objectives. This functionality may be supported by bibliographic citations automatically embedded in each extract that link back to original publications, and from links within the original publications to the liquid publications containing extracts from that original work.

The present invention, in yet another aspect thereof, may provide a means by which an individual publisher may manage its own collections and third party aggregation projects by implementing the solution provided by the present invention. In this aspect, the web accessible content may carry the brand of the rights holder. The rights holder may include content from its own collection, including 3^{rd} party content if permissions are granted. This may provide another way for the present invention to “seed” the market, encouraging rights holders to create and manage their own liquid publications using the methodology provided by the present invention. A next step may involve linking each rights holder's initiatives into a single umbrella product, as described further below.

The present invention, in a further aspect thereof, may provide a web based computer program for interacting with the system of the present invention. The computer program may follow the Service Oriented Architecture (SOA) model. The computer program could be written in any language operable to execute as a web service, such as Java™.

The system provided in the present invention may be augmented and enhanced by users by enabling full collaboration between and among content rights holders, content creators, application developers and content consumers. For example, application developers in education, reference management and course management could craft application programming interfaces (APIs), or mini-applications to run on the system platform. Such an API may be, for example, citation and reference management tools provided by a reference provider or course management tools supporting the system's content management aspect.

The present invention may provide rights holders a low risk sales and marketing channel in the sense that rights holders may access new business opportunities without new capital investment while benefiting from the incremental revenue derived from sales. This includes, in one aspect of the present invention, a SaaS (Software as a Service) model, in which the present invention is private labeled to publishers so that they may parse, compile and disseminate their own proprietary content and 3^{rd} party content for which they own the appropriate permissions. The general usage of a SaaS model is known to those skilled in the art. The present invention utilizes this model to provide rights holders with an optimal revenue model with respect to dissemination of content.

Finally, the system of the present invention could be provided in any one of a number of configurations. This may include wired or wireless access, and access via computers or hand held computing devices such as computer-enabled mobile phones, PDAs, etc.

### System Overview

The system of the present invention may comprise a front end aspect and a back end aspect, which are associated to each other in that the front end aspect is operable to query content stored in the back end aspect and display information to a user based on such content. The front end aspect may provide a plurality of utilities for several types of users to interact with the system. The back end aspect may provide a means to deal with the content, users, and related information provided to the system.

The front end may comprise three web-based user utilities, which are more fully described further below:
1. A rights holder utility may enable rights holders (such as authors or publishers) to include content for consumption by other users, and manage the conditions and rules for use of the content.
2. An editor utility may enable users (for example, professors) that wish to create and manage compilations of works to search, retrieve, organize, collaborate, include their own content and applications, and publish the resultant digital publication (for example, a liquid textbook) to consumers (for example, to students of a course)
3. A consumer utility may enable users to register, purchase, access and interact with the content and embedded applications of a digital publication (e.g. liquid textbook).

The back end aspect of the system may comprise a database operable to store contributed content; content information such as prices, permissions, and dissemination restrictions; user identification information such as login information and permission levels; and user purchase information with respect to purchased content.

### User Types

Various levels of access may be provided by the front end utilities to the back end system, based on privileges allocated or granted to the various users of the system. Several types of users may be defined, including administrators, rights holders, editors and consumers, which are each described below. Additionally, users may hold multiple roles such that, under certain conditions, it may be possible for a user to be one, a combination of, or all of rights holder, editor and consumer. Privileges may be granted in accordance with the following:
1. An administrator may be granted access to all user utilities, in all roles.
2. A rights holder may be granted access to all user utilities including full rights within the rights holder utility and editor utility, and guest access to the consumer utility which may be converted to full access if the rights holder joins (and pays) for a specific digital work. Examples of rights holders may be commercial publishers, academic presses, researchers, scholars, academics, artists, producers, or software rights holders.
3. An editor may be granted access to all user utilities including full rights to the rights holder utility and editor utility, and guest access to the consumer utility which may be converted to full access if the editor joins (and pays) for a specific digital publication, or is the creator of that specific liquid work. Examples of editor may be the administrator or its agents, professors and teachers, subject matter experts, editors at commercial content distributors, subject matter experts at companies, firms, and organizations, a person wishing to create a compilation work, or any other aggregators of works.
4. A consumer may be granted access to the consumer utility, being given the ability to deal with the particular works for which the user has paid, or otherwise been granted access. Access to the rights holder utility and editor utility may be granted on a limited basis if the user has produced a work that merits inclusion, such as a peer-reviewed paper, in the database of the system. Examples of consumers may be students, subject matter enthusiasts, or any purchaser of digital works including text, audio, video, or mixed works.

The system and method of the present invention may provide each user with a single identification means (such as an ID number or user identification string with password) to access the plurality of functions provided by the present invention. The given identification means may be associated with a plurality of attributes reflecting the individual user's access rights and permissions related to the system and the works stored therein. For example, a university student may use her school email address or student number to access each of her liquid textbooks, and may not require a separate identification means for each separate title.

Each of the utilities may be accessed in a secure, password accessible environment as further described below. Users may also have their identities and information protected using a suite of digital rights management, security and privacy tools, which are known to those skilled in the art.

### Rights Holder Utility

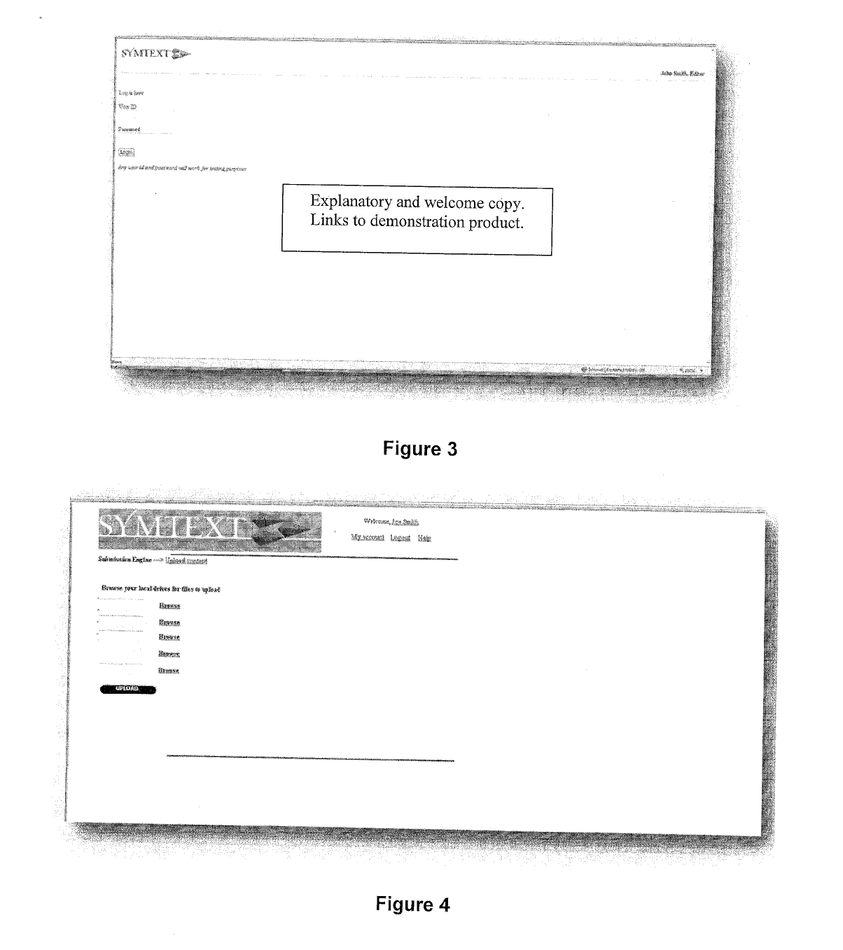

FIG. 3 illustrates one aspect of the present invention whereby a secure authentication form is provided for granting access to the rights holder utility. Any of several authentication schemes known to those skilled in the art may be used.

The rights holder utility may provide a means for rights holders to contribute or upload content and/or applications to the back end aspect of the system of the present invention.

Content may be contributed or uploaded by various methods, including using secure online forms, APIs, FTP, email, disk or other physical storage device, or other methods for transferring digital data. Once content has been contributed, the user may set prices and permissions for each work or element thereof (such as, for a literary work: paragraph, page, chapter, digital learning object, etc., or for an audio work: album, song, clip, podcast, etc.).

FIG. 4 illustrates one aspect of the present invention whereby a secure online form is provided for depositing content to the back end of the system. In this aspect, a web page may be provided whereby a user may select a one or more content files located on a local computer disk drive. The web page may also enable the user to upload the selected content, such as by using a submission button.

Content may be contributed in multiple file formats including, but not limited to text, media, data, presentation and graphics content. Documents including text, graphics, and embedded media content may be stored using XML or non-XML to arrange the various content components.

The user may distinguish versions of works (edition 1, 2, 3 etc.) and set different conditions for each version, including whether it is live (i.e., accessible to editors and consumers), the prices associated with the version or elements thereof, and permissions associated with the versions. An editor who disseminated a previous version of content may be provided with an alert, via the editor utility, when a rights holder uploads a new version of that content. The editor may decide whether or not to use the new version. This may be provided by the editor utility, which may provide a means by which the editor may disseminate the new version of the content in place of previously disseminated versions of the content. Thus, a consumer that accessed, for example, a liquid work containing the previous version may automatically be provided with the new version upon the editor's direction.

Dissemination of versions of works is further discussed below.

In one aspect of the invention, a request-response method may be used for contributing content. An editor or consumer may desire to access a particular topic or genre of content. It may be the case that an editor or consumer is able to locate such content in the system, and it may be the case that the editor or consumer cannot do so. In either event, the system may be operable to deliver a notification (by email or other messaging means, for example) to a content provider, notifying them within the rights holder's utility of a request for content. The request may identify the editor or consumer making the request, the context of the content request, and the “incumbent” content for reference purposes. The request may also include further elaboration of the context of the content, if provided by the requesting user. The request may ask for either a specific work or works, and any content that they feel relates to the context, or that the rights holder uploads any content that they feel relates to the context. Such a feature may be enabled by providing the system with a full catalogue of titles owned by the rights holder, even when such titles are not provided in the system. In this aspect, an editor or consumer may select the title, and if not available, a notification may be sent to the rights holder.

The contributed content may then be organized using a unifying taxonomy classifying content by structure (e.g. page, chapter) and subject (e.g. Porter's 5-Forces, Strategy). The content may be parsed (e.g. paragraphs on a page, or clips of an audio work) and discrete prices and dissemination conditions may be specified for each parsed piece of content. Dissemination conditions may be made separate and distinct from the “parent” file (e.g. in the context of a literary work, dissemination conditions of a page and chapter may differ from those of the entire work).

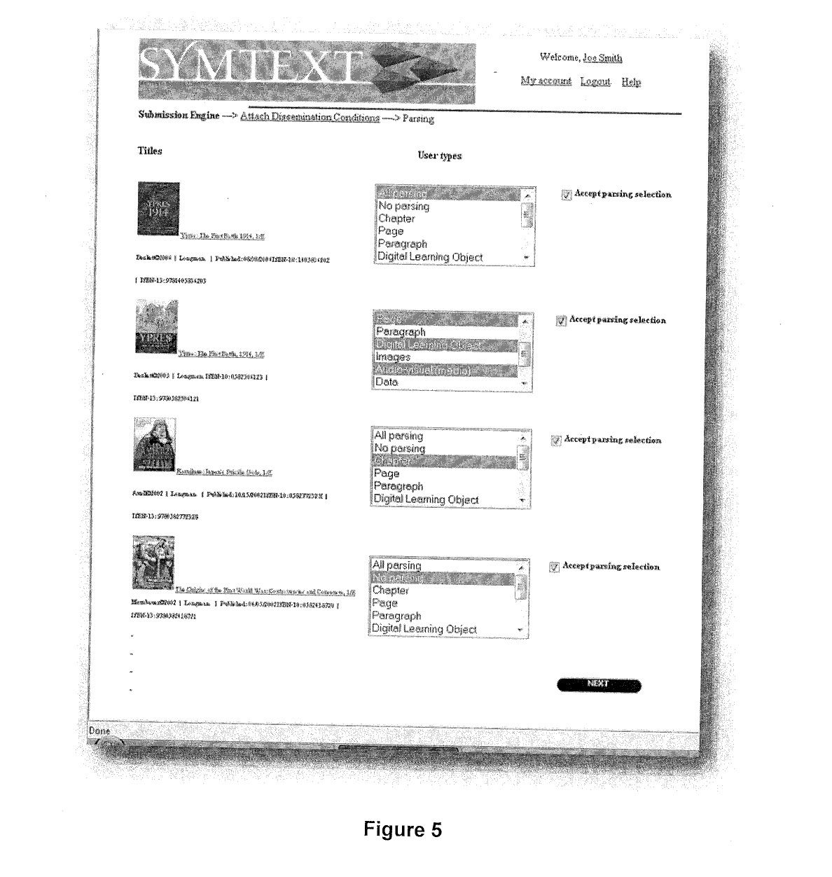

FIG. 5 illustrates one aspect of the present invention whereby a form is provided for specifying the types and degrees of parsing of each of a plurality of works. In FIG. 5, the works are literary work, but the methods used in FIG. 5 could be adapted to any type of work. A rights holder uploading the works may select a type and degree of parsing for each work. In the context of literary works, this could be by chapter, page, paragraph, digital learning object, etc. Where audio or video is included in the work, these elements may also be parsed into appropriate elements.

The rights holder utility may also provide tools to: set rights and permissions over the dissemination of contributed content; set prices on each element of their content (e.g. complete works, chapters, pages, data sets, images, audio or video files, simulations, updates, annotations, previous versions and editions, etc.); enable rights holders to view reports disclosing where their content is being used, in what form (e.g. chapter, page, image etc.), by how many people, what their pending royalties will likely be (based upon rates they have set); examine historical data for trends and other information that aid decision making; and to make changes to prices and dissemination parameters to maximize their objectives (e.g. revenue, reach etc.). The rights holder utility may also include a means for a user to view files; view, track and manage conditions (price and dissemination) using a “dashboard” to maximize rights-holder objectives (e.g. reach or revenue); and provide security and privacy solutions to protect against unpermitted data and information leakage. Each of these are now further described.

The present invention contemplates that the various activities enabled by the invention, including those described above for the rights holder utility, and also more general information regarding demand for specific content, or interaction with specific content (including the various social networking functions described below such as the ranking, rating, discussion) can be captured to a database and associated with a reporting utility that may enable search based queries to obtain data regarding demand or interaction with specific content or categories of content. For example, the present invention may enable the creation of usage and interaction metrics for content that may be provided to rights holders, editors, or publishers. The resulting metrics may assist rights holders, editors, or publishers in making such decisions as topics to be taken up by rights holders for future content, content to be included in future compilations by editors, adjustment of content distribution by publishers or changes to the content in relation to which the publisher wishes to obtain rights. As a specific example of use of this function of the invention by a publisher, the publisher is able to track the relative popularity of one out of several chapters in a book, and accordingly make chapters available separately, and certain chapters at a higher price than others, and also promote popular content more extensively. Similarly, distribution permissions and conditions may be adjusted on a go forward basis so as to optimize revenue and dissemination objectives.

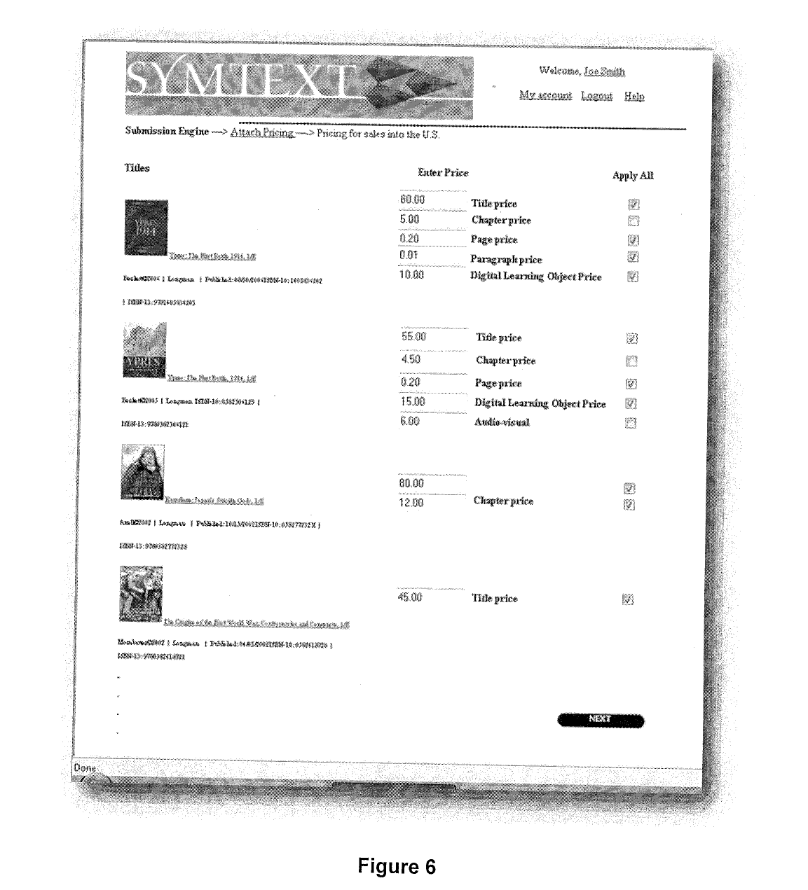

FIG. 6 illustrates one aspect of the present invention whereby a form is provided for specifying prices for each of a plurality of element types and each of plurality of works. Each unparsed work may be priced as a whole, and each parsed work may be priced based on each of the different types of parsing previously specified by the rights holder.

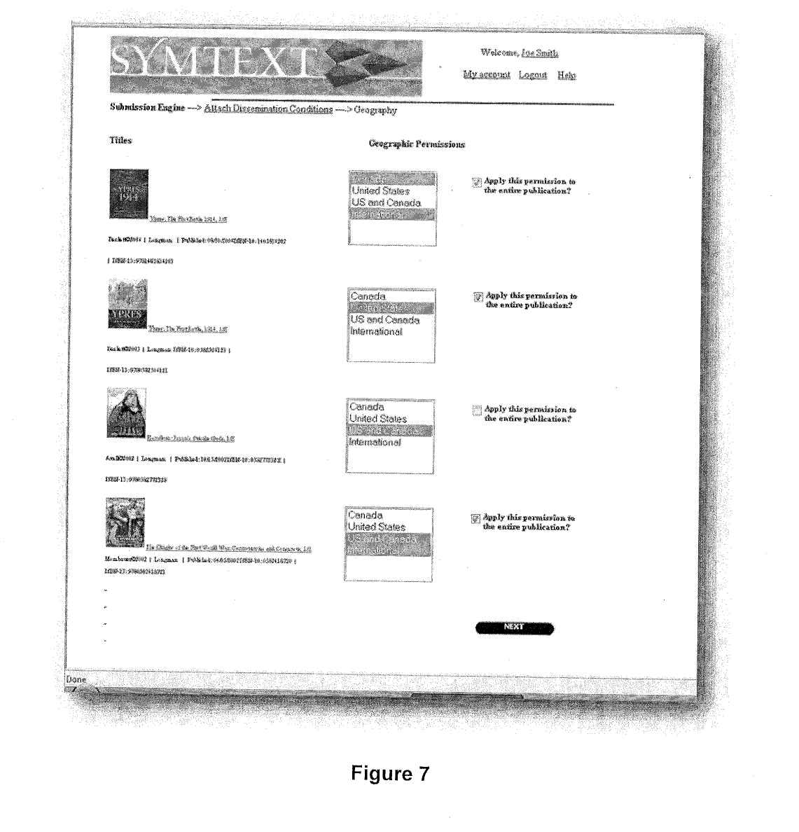

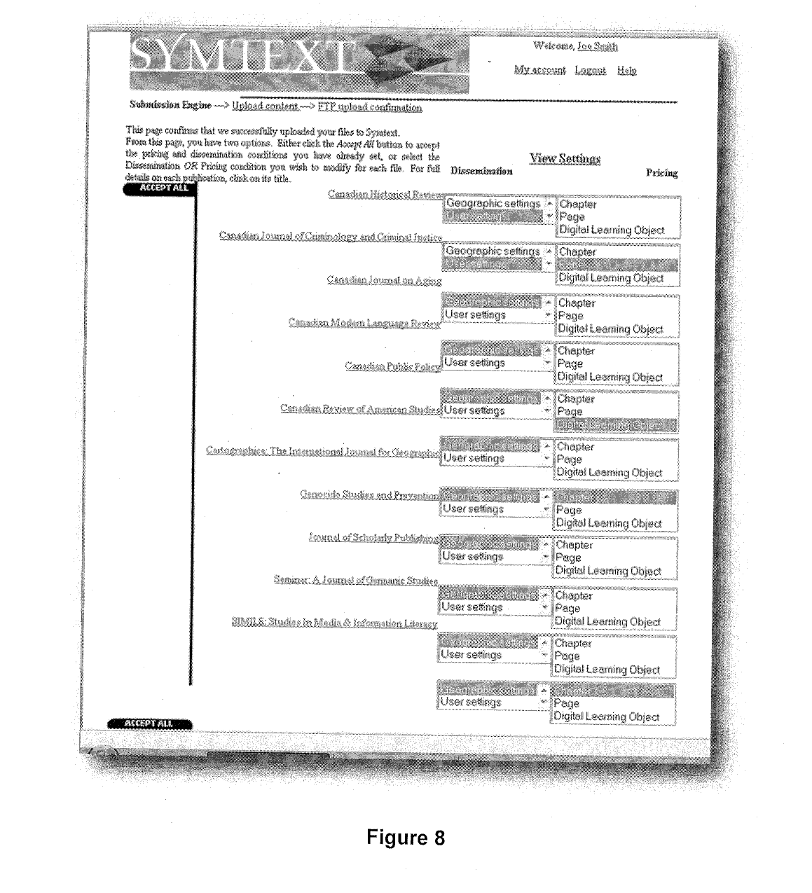

FIGS. 7 and 8 illustrates one aspect of the present invention whereby a form is provided for specifying dissemination conditions, which may include regional conditions, for each of a plurality of works, and the portions of works among which conditions are specified. The rights holder may specify the regions within which a consumer must be located in order to access the work or elements thereof. A rights holder may stipulate exclusions (content that may not be shown) in the form of a “black list” (a list that itemizes content that may not be displayed). The system may also be operable to require that a rights holder warrant that it holds the right to allow the administrator to disseminate the content provided. The rights holder may be provided text outlining each parties' obligations with respect to copyright and then indicate its acknowledgement to having read, understood and agreed that it is the rights holder and has the right to determine the conditions under which the content may be disseminated. Further to specifying the regions within which content may be distributed, a rights holder may specify the same or different pricing for each such region. This may enable a rights holder to respond appropriately to market conditions within each region. It should be understood that by “pricing” includes the notion of content being priced for “free”.

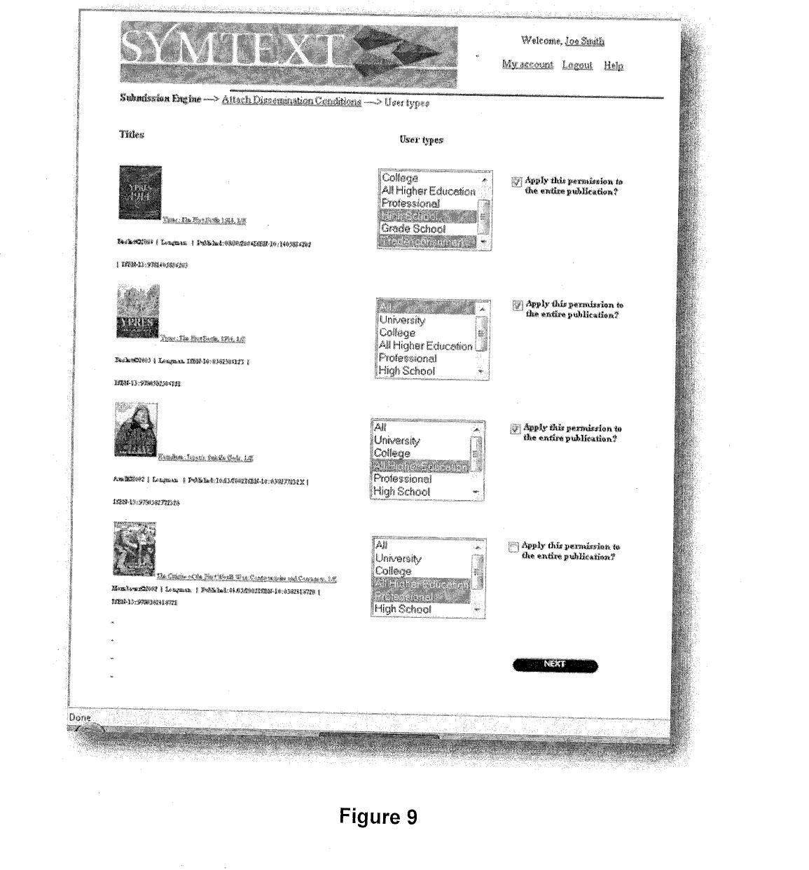

FIG. 9 further illustrates a form providing dissemination conditions being specified based on consumer types, such that a rights holder may limit the types of consumers that could access the works based on one or more particular class levels. Types of consumers may be specified based on any criteria an administrator may see fit to define. Furthermore, a rights holder may specify the same or different pricing for each user type. This may enable a rights holder to respond appropriately to market conditions among various consumer types.

There may be four types of users given access to the rights holder utility, each with differing levels of access permissions: an administrator, a rights holder administrator, a rights holder user, and an unregistered user.

An administrator may be granted full access to all data and information including the ability to make changes to permissions and prices with consent from the rights holder.

The administrator, with permission from a rights holder, may change prices and permissions of that content. Pricing and dissemination conditions may be stored as meta-data to the associated content files. In one aspect, for large scale publishers with multiple publications, an API may be associated with content from that publisher. A rights holder may copy files to an FTP server, for example, and the database of the system may be updated accordingly, either on demand or on a schedule. A rights holder may be notified that the upload is complete. In one aspect of the present invention, the act of uploading may be considered approval to make the content available for use and distribution. A rights holder may be reminded that they may change, add or delete pricing and dissemination conditions at any time. If rights holder files do not contain meta-data outlining pricing and dissemination conditions, the rights holder may be notified and directed to the rights holder utility. Content may not be made available until price and dissemination conditions are stipulated. An administrator may search or browse this content on behalf of the rights holder by: searching or browsing content titles and associated portions of works; changing the prices and/or permission conditions for works or elements of works, optionally requiring the rights holder to activate any changes (activation may be provided by generating an email to the rights holder, requesting that they login, view the new prices or permissions, and approve changes); and declaring peer-review status (in the context of an academic literary work).

A rights holder administrator may also be granted access to view, browse, read and download content (whether their own or from another rights holder or editor) within the system. The system may be operable to enable the rights holder administrator to utilize the editor utility or consumer utility to execute these functions, as the rights holder administrator may be beholden to the same restrictions on redistribution as any purchaser, as they may also be accessing content from other rights holders.

A rights holder user may be granted access limited to uploading content and approving content for public access (i.e. making content “live”). Access by the rights holder may also be provided through a secure authentication means, as described above. The rights holder user may contribute or upload content and related schemas describing the content's subject and structure (such as an XML schema).

The rights holder user may also be provided with a means to review content in the database. The rights holder utility may be operable to present a list of works (listed by title and/or version) to the rights holder as a set of links to those works. The rights holder may select an individual work by selecting the associated link, or several titles by using a means for multiple selection, such as check boxes in the web service aspect of the present invention. The rights holder may alter the status of a work by making it live, or private, and then saving the selection.

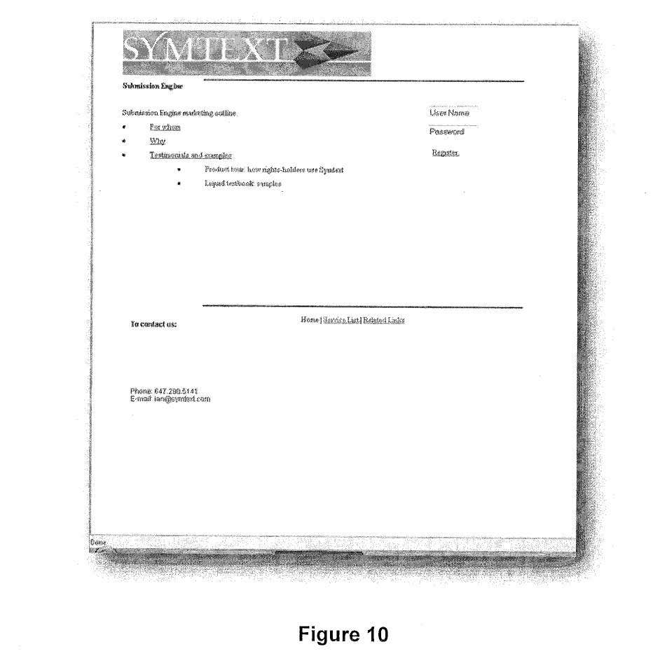

An unregistered user may also access a limited portion of the rights holder utility. FIG. 10 illustrates one aspect of the present invention whereby a web page is provided such that an unauthenticated or unregistered user to view the rights holder utility. The web page may provide information on how to login and register with the system and may include explanatory information on the means of registering with the system. A link may be provided to a registration page.

The unauthenticated or unregistered user may also be provided with a display of one or more representative pieces of content so that the user may be made aware of the appropriate quality of content to be provided to the system. This may help to keep the system free of poor quality content.

Optionally, the user may also be shown features and benefits, testimonials, how to get started, and instructional information for the system. If the unauthorized or unregistered user wishes to register with the system, a registration utility may be used.

Creation and registration of IDs may include a means to provide a unique identifier for each rights holder entity (e.g. company, organization, individual). Each rights holder entity may have more than one login, to accommodate different divisions or groups within the entity, each potentially having different levels of permissions governing access to works and associated information (prices, privileges, etc.).

A rights holder may stipulate the maximum number of required IDs, which the system may record. In this case, a new login/password combination will not be granted once the maximum has been reached.

The system may create a digital key for each required ID. A rights holder may register using the key and create an ID and password combination associated with each key.

In one aspect of the present invention, reporting tools may be made available to administrators, rights holder administrators, and rights holder users in accordance with which these parties may be able to provide optimal pricing and dissemination conditions for content.

The reporting tools may provide a plurality of reports that present data to the particular parties. The data may be useful to administrators, rights holder administrators, and rights holder users for increasing sales of works. For example, administrators, rights holder administrators, and rights holder users may be given access to reports based on individual rights holder performance such as utilization (i.e. how much of a given rights holder's content is being used) among a group of users or all users; adoption (i.e. the rate of purchase) among a group of users or all users and based on time of purchase; and royalty performance among a group of users or all users. The administrator may also be given a report comparing adoption of content compared to other similar content in the system.

These reports may provide useful data to administrators, rights holder administrators, and rights holder users in accordance with which the applicable party may alter pricing and dissemination conditions of content, in an effort to create a more effective marketplace for content that may increase sales of works based on usage data by editors and consumers and editors.

### Editor Utility

The editor utility may provide a means for editors or compilers to work with content contributed by rights holders to the back end aspect of the system of the present invention.

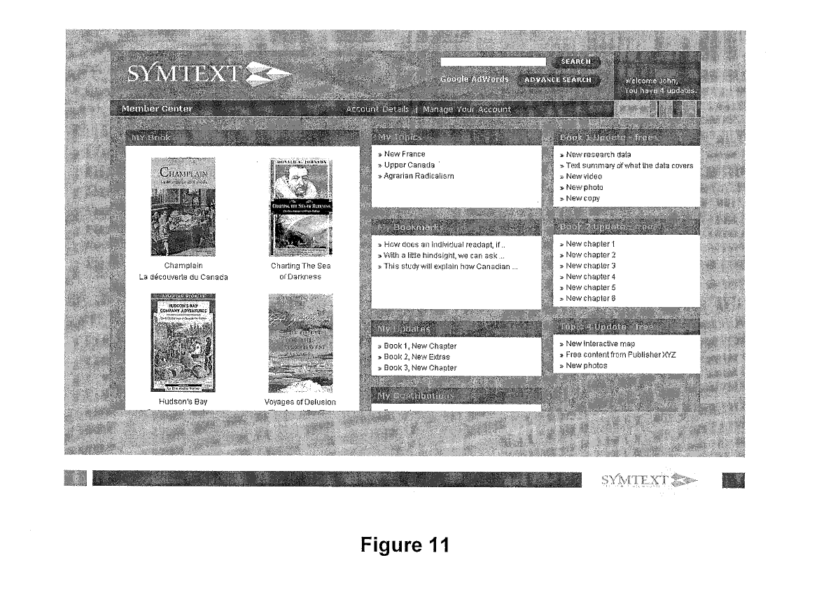

FIG. 11 illustrates a home page accessible within the editor utility. The editor utility may be accessible from a home page or landing page, wherein an editor may be provided with a plurality tools. For example, the home page may provide means for the editor to create a new liquid work or search the repository of works or of a larger network such as the Internet.

The home page may also provide means for the editor to view existing liquid works previously created by the editor. An editor may view statistics corresponding to a liquid text (such as how many users have accessed or purchased rights to view the liquid text, or information relating to when specific users accessed the liquid text).

The home page may further provide means for the editor to view groups or collaborations. An editor may be provided with a list of invitations to groups that the editor has both sent and received. An editor may accept, decline, or ignore requests received. The list may also display the last update to a group, such as by displaying a snippet of the most recent message posted to that group. Groups and collaborations are further described below.

The home page may additionally provide means for the editor to view uploaded original content by the editor. An editor who accesses this function may be redirected to the rights holder utility, where they may be provided further tools, including for adding or removing content.

The editor utility may provide tools to: search, retrieve, tag, annotate, edit and organize third party content from multiple rights holders; embed their own content with or without fees to consumers; control prices of liquid publications to consumers; embed their own applications (e.g. e-learning apps) with or without fees to consumers; track usage; amend existing versions of content aggregations; create, store and reuse multiple versions of content aggregations; collaborate, interact and debate with other editors; share their works and utilize the works of other editors; publish works to users and/or peer-review groups; communicate with constituents (e.g. students of a class) and other editors; and establish mandatory or non-mandatory responses from constituents (e.g. comment on assigned readings).

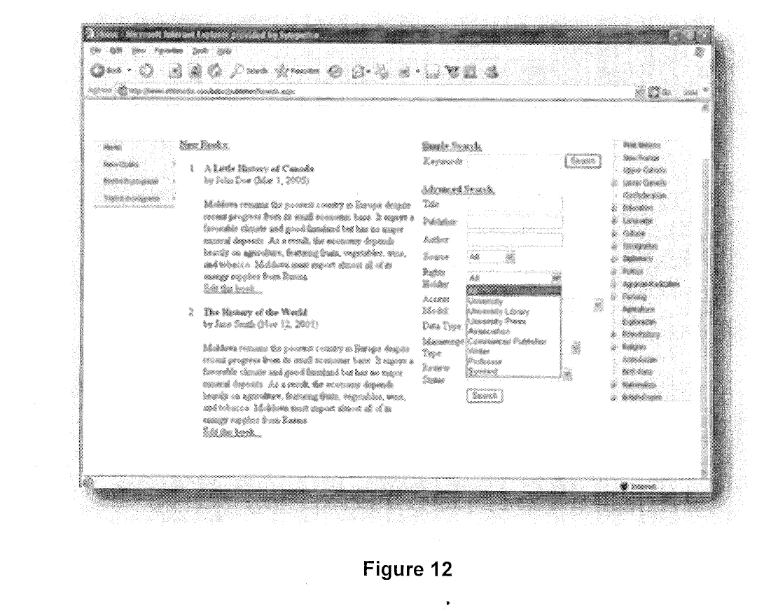

FIG. 12 illustrates one aspect of the present invention whereby a web page is provided for searching the database. An editor may search either by full text, or by fields that may include but are not limited to subject, file format, title, version, author, publisher, or other characteristic of a work; by the permission status as set by a rights holder; by rights holder type (e.g. commercial, academic, scholarly, individual, etc.); by review status (e.g. in the context of academic works, peer-reviewed or non-peer reviewed); or by type of content (e.g. search only within a title, search only within comments about the title, search both within the title and related comments). The editor utility may also enable a saving feature wherein an editor may save their search

Searching the database may be enabled through any search means known to those skilled in the art. For example, a Boolean full text search may be provided. Optionally, an editor may search within a work with the same functionality as searching the database.

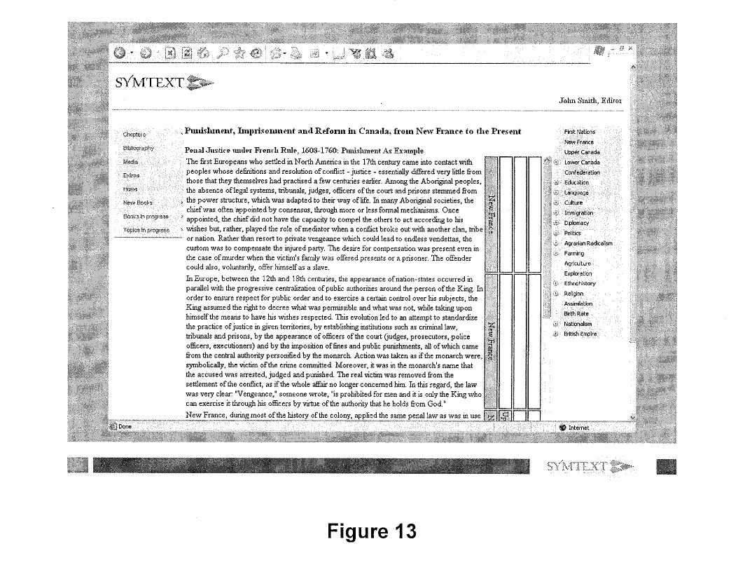

FIG. 13 illustrates one aspect of the present invention whereby a web page is provided for retrieving and examining content returned from the editor's search previously illustrated in FIG. 12. The returned content may comprise original works and liquid works. The results may include only those works in which access permission has been given. The results may be displayed as a summary (such as a Table of Contents for a literary work or a course outline) for ease of use.

The system may be operable to store title information for known works that have not been contributed to the database. In this case, the titles of these works may be displayed in the search results. Where an editor chooses to select such a title, an alert may be provided to the editor that the title is not available, and a request may be generated to the rights holder to contribute the content if so desired.

An editor may also browse the database using a menu system. The menu system may be arranged hierarchically, arranged by discipline (e.g. Humanities→English→English Literature→Canadian fiction); publisher (e.g. Pearson Canada→Disciplines→Available Titles); or liquid work (e.g. discipline→professor→course). An editor may, upon reaching an appropriate liquid work, view either a digital or both digital and print prices per each unit of content (e.g. page, media file). Content may be displayed by title, chapter, page, paragraph, digital learning object, or any other ordering means appropriate to the type of media being browsed. Portions of content may be displayed along with the title for the editor's reference. In one aspect of the present invention wherein a web based interface is provided, portions of content may be displayed in a floating text box when a user mouses-over a title. An editor may save selected content or view pricing or dissemination information for that content.

There may also be a means provided for searching the Internet from the editor utility. Such means are known to those skilled in the art. Optionally, an editor may use such means to locate works outside of the database and import out-of-copyright and/or Open Access (e.g. Creative Commons) works into the system. In this case, the same parsing choices may be given to the editor as are provided under the rights holder utility. The editor may be required to warrant that they are responsible for ensuring that web content they have selected may be included.

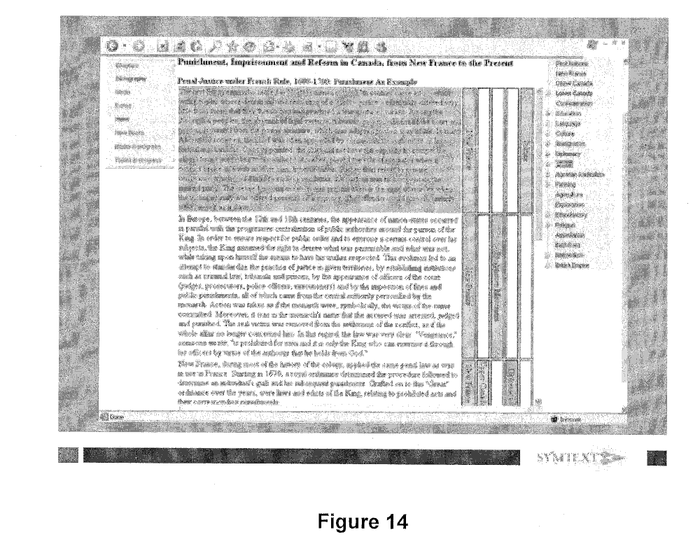

The results of a search or browse may be displayed in an ordered list, ordered by title or relevance, for example. An editor may desire to select, for inclusion in a liquid work, titles presented as a result of the search and browse functions. FIG. 14 illustrates one aspect of the present invention whereby a web page is provided for allowing an editor to select extracts from available works for compilation to a liquid work. An editor may also tag and annotate any of the content, including text, data, media, image and graphic file types, if they so desire. Tagged content may be displayed, and the total price for such content may be provided to the editor.

Optionally, the system may be operable to enable the storage of one or more “favourites” lists associated with each editor. The editor may tag content as they come across it, and it may thus be added to a favourites profile. A favourites list may be generated based on the profile by analysing the discipline or other characteristics of tagged content. Various algorithms for analysing characteristics such as this may be used, as known to those skilled in the art.

The favourites list may display: most relevant elements, by discipline; most relevant elements, overall; most relevant works, most referenced works (by other editors, for example); most cited works; most commonly disseminated liquid works (where permission from the editor is has been granted); or any other characteristic desired.

Also optionally, a means may be provided wherein editors may provide reviews and ratings of content or content elements. An editor may contribute reviews of elements and view the aggregate ratings and comments of others.

Finally, a means may be provided for an editor to view content disseminated to particular consumer groups. For example, in the context of university course liquid textbooks, an editor may choose to view works disseminated to first year undergraduate students as opposed to second year undergraduate students.

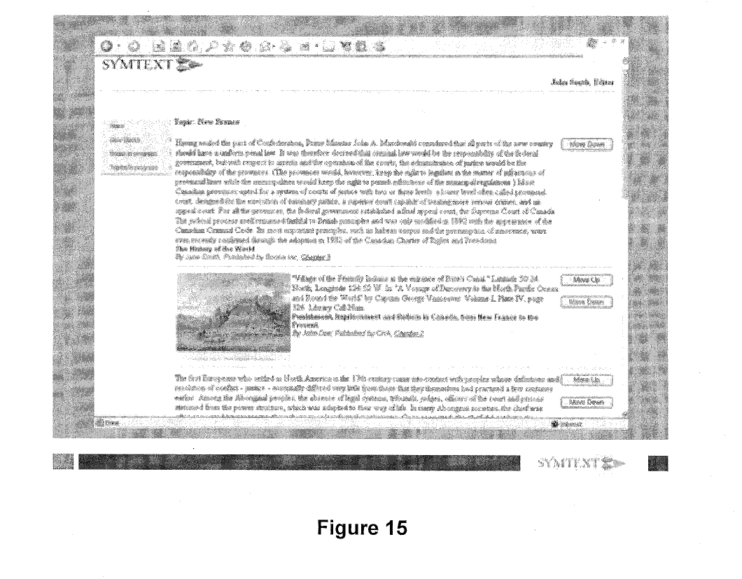

Following the selection of extracts, an editor may organize content into a liquid work. FIG. 15 illustrates the organization of content. A display authoring tool may be provided for use by the editor. Upon accessing the display authoring tool, the editor may be presented with an organized selection of content. Initially, the extracts of content that the editor selected (or tagged) may be presented on a single page in a list ordered by time of selection, alphabetically, date of creation of content, or any other ordering method. The editor may be provided means to reorganize the extracts as desired, such as dragging and dropping titles of content to a different location in the ordered list.

The editor may also be provided means to insert original content or applications between any pieces of content, providing pricing information for any of his or her original content and applications, and view and approve final delivered digital and print price, which may be partially determined by prices of content set by rights holders (i.e. an editor may tailor pricing by adding or removing content as appropriate). It should be noted that the rights holder may provide a wholesale price to the administrator of the system, who may then add a mark-up. The administrator may then pass along a retail price for each piece of content to editors. The editors may then determine what to include or exclude, with the price to users being one aspect of his or her decision making. Optionally, the editor may also add a royalty price for the liquid work itself. Pricing is further described below.

In the context of a course textbook, an editor may desire to embed questions or other interactive content in line with the content. Questions may be implemented using a form to which a consumer must respond before moving to the next piece of content. Commentary may also be added to any content or between pieces of content. Once all of the organization steps have been performed, an editor may view and approve the final liquid work and set a digital and print price.

The liquid work may then be given context, such as designating topics or genres which are related to the work. This information may be useful to a consumer or editor searching or browsing for the work. For example, in the context of a course textbook, an editor may specify the course for which the work relates. In the context of a musical compilation, an editor may specify the musical genre for which the work relates.

Optionally, the editor utility may provide a means for an editor to enable automatic updating of the editor's liquid work, based on a rights holder contributing a new version of content related to incumbent content already in the liquid work. In this aspect, when a new version of content is made “live” it may automatically replace the incumbent content in any liquid work wherein such a feature has been activated. Alternatively, upon a rights holder contributing an updated version of content, a notification may be sent to an editor of a liquid work requiring the editor to trigger the update. Once triggered, the updated version may replace the incumbent content in the liquid work.

Once the editor has completed organization and contribution to a liquid work, the editor may view and approve a final delivered digital and/or print price. Thus, in accordance with the above, the editor may be provided with a means to view both the prices (digital and digital/physical) for each piece of content they have selected and to see the total price (the sum of the selected pieces) in both digital and digital/physical delivered prices. The editor may then add or remove content until it reaches a final delivered price the editor is comfortable with. Thus, pricing control is passed to the editor. As specified above, the editor may wish to add a royalty price for the liquid work itself.

The editor utility may further provide means for collaboration between editors on new content or new applications. A collaboration tool may enable communications that may be fostered through the use of online discussion groups, or forums, blogs, and other tools that support commentary, discussion and debate. Different viewpoints may be provided for any given content by allowing editors to comment on content. Commentary can be displayed to consumers or kept within a group or forum.

Collaboration may be facilitated within groups, or by making editors' files searchable. A group may be created by: inviting members to the group; accepting or rejecting applications to the group; make the group findable in searches by other editors, or making it private; writing a group description, which can optionally be read by all editors, or only those who are invited; and uploading content from contributing editors to the group. Uploaded content may be new works, liquid work, or extracts from content in the repository. Editors may collaborate upon organization of the content (i.e., creating a liquid work), or collaborate upon content and/or application development. Collaboration may also provide a medium by which to edit content.

Editors may share completed works, works in progress, or portions of works. The collaboration tool may enable selection of content to be shared. Where elements of the work, but not the entire work, are to be shared, the editor may stipulate both how the content is to be parsed (acting as a rights holder) and the terms (dissemination and price) under which it may be accessed and used. Any unselected content may not be displayed in a search.

Commenting on one editor's work may include a second editor, upon retrieving content created by the first editor, privately commenting upon that content, which could take the form of an invitation to collaborate or a comment upon the content itself. With both editors' consent, the commentary surrounding given content may be made public, to foster discussion among more editors. From this exchange of ideas, the discussion may be formalized into a group. Many to one commentaries (i.e., more than one person commenting upon a single piece of content) may be merged into a single group, with the permission of each participant.

As described above, editors may share their completed liquid works. In this case, editors may be required to first obtain explicit permission of the rights holder, which in one aspect of the present invention may be provided by a check box. The liquid work may then be treated as a copyrighted work, and the editor may be treated as a rights holder. The editor may set price and dissemination parameters for the work, the price being attached to the delivered price to customers (but not charged to other editors). A liquid work may then appear in search results, and may then be adapted by other editors.

The editor utility may also provide a means for publishing liquid works. Works may be: published to selected groups (such as peer review groups who, if registered in the system, would be presented with the liquid work and may then comment on its organization and content); published privately (in which case the work may only be accessed as a preview); published publicly (accessible to consumers and other editors); and associated with pricing and dissemination conditions as described above. When a work is published, the work may optionally be appended with indexing information. For example, in the context of a textual work, a published work may be paginated and indexed, and a table of contents may be created.

A messaging facility may be provided for groups, to facilitate communication among the group members. The groups, which may be associated with particular liquid works, may communicate using the work. For example, questions or notations may be attached to content within the work. Other users of the liquid work may then be presented with the question or notation, and may be able to respond if desired. Notifications may be sent to users if such questions and notations have been made, so that the user may be made aware that a message has been sent in connection with that particular work. Optionally, notifications may be sent over an alternate medium such as e-mail. Messages such as notifications or questions may also be posted to user groups as they are known to those skilled in the art.

The editor utility may provide a means for an editor to send a liquid work to a printing partner for physical production.

The editor utility may also enable editors to view summaries (such as tables of contents) of other liquid works, and adapt these into new liquid works.

The editor utility may also provide reports to editors on the use and dissemination of their liquid works and works upon which their liquid works are based. The reports may be similar to those described above in relation to the rights holder utility.

The editor utility may be made accessible to administrators and rights holders. Access to guests may also be provided, wherein rights holders may be granted temporary access to the editor utility. Access under these conditions may be granted in order to provide rights holders with knowledge of how editors are able to use rights holders' content in liquid works. In this aspect of the system, rights holders may be provided with a sense of transparency in the system of the present invention. In another aspect of the system, a rights holder using the editor utility may use a private labelled version of the system to repackage their content into new liquid works for further dissemination. Under this aspect, the rights holder may be regarded as an editor.

Unregistered users may also be granted access to the editor utility. Access may be granted to a generic welcome page presenting information explaining the system and the editor utility. This may be provided in a similar fashion to the above mentioned welcome page in connection with the rights holder utility. A demonstration product based upon sample content may be presented. An unregistered user may proceed to register in a similar fashion as described above, by providing contact information and completing registration fields.

An administrator may be granted full access, using a secure login tool, to the editor utility. The editor utility may be operable to enable the administrator to access all utilities accessible by the editor. The administrator may also provide liquid works updates to displayed groups; view own uploaded files; and add or remove content (a feature that may be enabled using a link to the rights holder utility).

### Consumer Utility

The consumer utility may provide a means for consumers to access content provided by rights holder and editors to the back end aspect of the system of the present invention.

The consumer utility may provide searching and browsing tools to enable access to content provided by rights holders. This may be provided using methods similar to those described in connection with the editor utility.

The consumer utility may also provide tools to access edited publications on either a paid basis, another form of conditional access (e.g. member of a scholarly society, participant in a class, student at an institution), or unrestricted basis. Consumers may access an online version but may also opt to have a printed version created by a print on demand (POD) service, which may be associated with the system. Consumers may interact with online content through blogs, forums, commentary, annotation, uploads (e.g. tests, assignments), or other media and may also collaborate with one another. Digital publications may also be downloaded and accessed on standard readers, such as those provided by Adobe™, Overdrive™, etc or standard audio or video players, as the case may be.

The consumer utility may be provided with a means for registration, so that a user may become a consumer registered with the system. Methods of registering with online systems are known to those skilled in the art. The ID generated by registration may be associated with permissions for accessing the plurality of works stored in the system. These permissions may be set based on which works and elements of works the consumer has purchased.

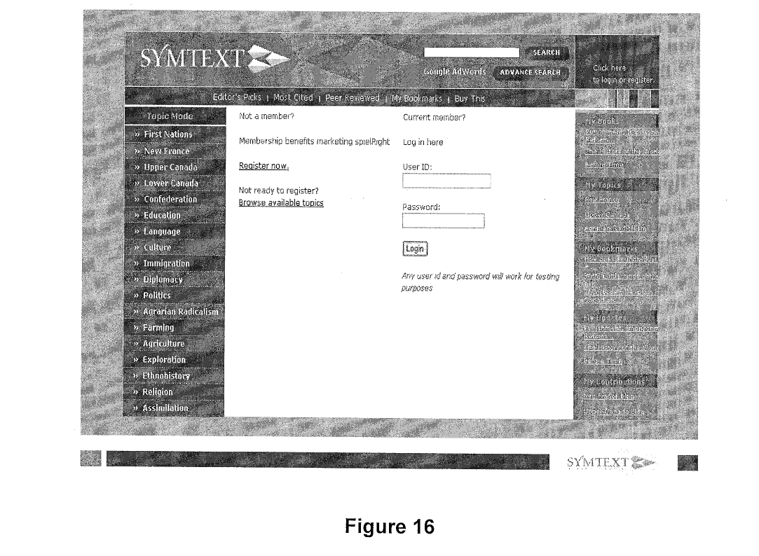

Once registered, a consumer may authenticate with the system. FIG. 16 illustrates a log in screen for a consumer, which may accept an ID and password combination to provide access to the consumer utility.

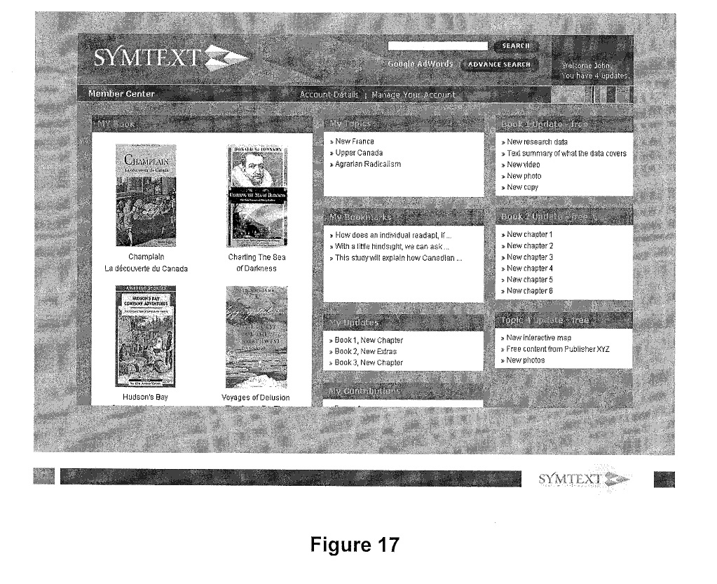

Once the consumer utility has been accessed, the consumer may be presented with a welcome page. FIG. 17 illustrates one aspect of the present invention whereby a welcome page is provided that is operable to display works which the consumer has previously selected.

If the consumer selects a work that has not been purchased, the consumer may be provided with a selection tool to choose the number of elements, and duration of license for accessing these elements, in relation to the work. A license may also provide the consumer with access to updated content based on new versions of the content being enabled by rights holder and editors. In this aspect of the invention, content purchased by a consumer may be replaced automatically with updated content, or a consumer may be provided a notification that updated content is available, in which case the consumer may be required to enable the replacement of the content. In this case, the consumer may be provided with a preview of the content so that they can make an educated purchase decision.

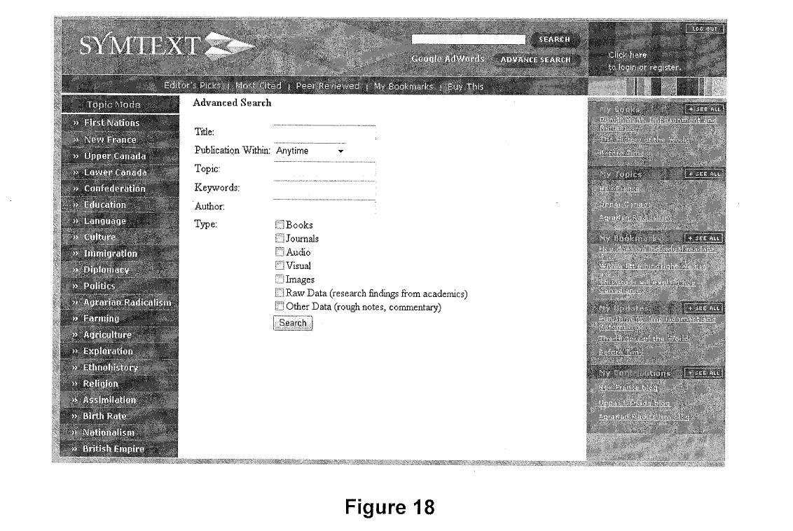

Means may be provided from the welcome page to access both previously purchased works and works that have not been purchased. FIG. 18 illustrates a search utility to search for works or elements of works based on various criteria, such as media, author, keywords, topics, or titles. A consumer may utilize the search utility to find works or elements of works related to a particular topic of interest. Search results may be displayed corresponding to the search. Alternately, an unlogged user may be directed to a liquid work by providing a digital address (such as an URL) in a printed version of the work. An unlogged user may enter the digital address into a browser (such as a web browser), which may result in the front page of the liquid work being displayed.

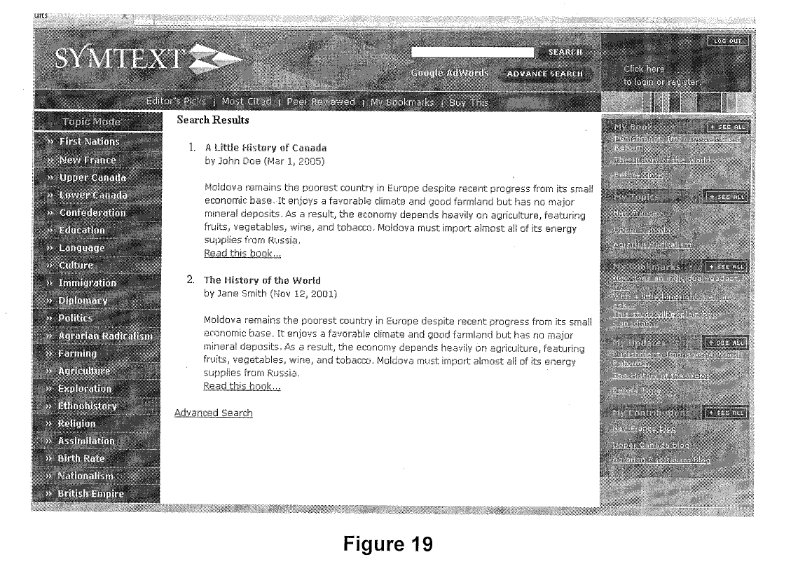

FIG. 19 illustrates one aspect of the present invention whereby search results and associated snippets of content are displayed to a consumer. A link may be provided with each result, operable to enable the consumer to purchase the work or an element thereof. A payment means, such as a credit card processing web service, may be used to facilitate payment for content.

Once purchased, the consumer utility may be operable to enable the consumer to access purchased content online or as a print version (using a POD service). The consumer may also interact with content, such as creating new content associated with purchased content; commenting or blogging on content; sharing content; responding to other consumers' dealings with content; collaborating with other consumers with respect to content; uploading new content; or inviting unregistered users to join the program.

Collaboration among consumers may be provided in a similar fashion as collaboration among editors. Consumers, with editors' and/or rights holders' consent (i.e., in accordance with pricing and dissemination business rules), may share content among organized groups of consumers for purposes of review or commentary of the content.

Access to content may be granted to consumers both online via web and device access, and offline via devices (readers, e-paper) and print. Web access may be provided through various hosts, including the database owner, a contracting party common to all consumers (for example, a university where the consumers are students), a rights holder (such as a publisher), or another provider.

The consumer utility, and associated features, may also be accessible by rights holders and editors, in which case they may be restricted to the same level of access as consumers.

Unregistered users may be granted access to an introductory page to the consumer utility. The introductory page may display preview content associated with a given liquid work (i.e. not the full content of an element) as well as links to login and registration pages. Optionally, a user may navigate to the preview content based from a physical, original work, in which a link is provided identifying the location of the liquid work. This may require that each liquid work be provided at a permanent link.

The consumer utility may be operable to display purchased liquid works. In one aspect of the present invention, elements within a liquid work are accessed from a front page. Newly added extracts to the liquid work, as well as changes, updates, and amendments to existing elements within the liquid work may be date-stamped or otherwise flagged for the user to easily see.

Extracts that are not conducive to being displayed in a single screen (such as text that is more than one page) may be displayed one screen at a time. This implementation may also provide an opportunity to use space on a page to direct a user to related topics, place limits on the ease of printing (which may help to limit piracy), and in certain consumer applications offer more screen space to place advertising.

Extracts may be preceded by the brand of the rights holder, and may be followed with a bibliographic citation and link to the full text of the original work. The original work may then be accessed with purchase or permission of the rights holder. Extracts may also be followed by a comments link, allowing consumers to comment or respond to requests for comment. All comments may be flagged in consumers' home pages, to encourage participation. Comment requests may also be emailed, with the permission of the consumer.

The consumer utility may enable a consumer to place a virtual bookmark within purchased works to make the location where the consumer has left off.

In one aspect of the present invention, content may be provided with XML wrappers. Rights holders may provide links within the XML files for linking elements of the work to other elements of the same work. In this aspect, a user may navigate from section to section using the links.

Consumers may be able to email content elements within a liquid work, but not the entire work. Consumers may print sections of the work but may not print it in its entirety unless purchased through a POD partner.

A method of marketing the existence of related liquid works or original works may also be provided by the consumer utility. Upon accessing the consumer utility, the front page may display to the consumer: an image of a front cover or other marketing material related to a physical version of a liquid work or original work; excerpts of content reviews related to the liquid work or original work; excerpts of introductory content from liquid works or original works (such as the first page of a book); tables of contents, indices, bibliographies, extras, or lists of new chapters of physical works; or related works or topics.

A user may reference a list of citations (such as a bibliography) of a liquid work in order to determine the source of a piece of content. The user may click a link associated with that content, which may cause the consumer utility to display the original work containing the content, if permission has been granted.

The opposite may be provided as well. A user may have access to a physical work, and may be interested in content provided in that work. The physical work may provide an address (such as an URL) to be entered to the system by a consumer for accessing the digital version of the work. Alternately, the consumer may access the digital version of the work by searching for it in accordance with the search functions in the consumer utility.

When a user accesses the digital version of the original work, they may be provided with a list of content pieces in that work. The user may select a particular content piece, and the user may then be provided with a list of liquid works that contain that particular content. The user may access the liquid work if permission is granted.

In this way, the present invention describes a method to market the existence of more content for a rights holder to sell and for a consumer to use, at their discretion. This may assist rights holders in achieving additional sales through an incremental revenue model.

### Purchase

The purchase of content may be provided using several means known to those skilled in the art, including a credit card check-out process or billing process. Payment may be made at the time of purchase, or a user may credit their account with funds, and deduct funds upon a purchase.

Consumers and editors may make purchases in digital and/or print versions. In the latter case, before the final price is calculated the user may select a print vendor and the type of print job desired (e.g. colour, customization, delivery options), upon which a final price is presented.

A successful purchase may generate a printable invoice, which may also be sent to the user through email or a messaging scheme provided by the system of the present invention.

The funds transferred by a purchase may be transmitted to the system administrator.

Royalties may be based upon rights holders' setting per unit prices. Units can be complete original works (e.g. book), chapters, pages, paragraphs, digital learning objects, media files, articles, data sets, images, liquid textbooks etc.

Royalties for a rights holder may be calculated as unit prices multiplied by units sold for each piece of content that has been exploited by the rights holder. Royalties may be paid at scheduled intervals, at threshold monetary amounts, or when requested by a rights holder.

Additionally, royalty payment calculations may be provided in which multiple rights-holders participate in a series of “royalty pools” (i.e., when multiple rights-holders are featured within one publication, the rights-holders may be placed into that publication's royalty pool, and may be paid from its proceeds).

Royalty payments may also be made in the form of guarantees that are not strictly tied to the usage of that rights-holder's content. There may also be provisions for making royalty payments to rights-holders by electronic funds-transfer. Implementations of each of these methods are known to those skilled in the art.

### Applications

The present invention may enable embedding of applications in liquid works.

In an aspect of the present invention, providers of intellectual property (IP) are given an opportunity to commercialize their IP. This may apply to developers of software applications that may run on the system of the present invention. The methods described above may be utilized by software providers to determine and set pricing and dissemination conditions on software applications. The software providers are, therefore, rights holders of the software applications.

Editors may embed software applications as they would other content in accordance with the methods described above. Thus, the software applications may be elements of liquid works as would any other form of media, such as text, audio, images, or video.

In one implementation of the present invention, software developers of e-learning applications may set pricing and permissions conditions for each application they offer. An editor who is a professor may desire to embed a particular e-learning application in a liquid textbook, for use by students. A purchase by a student consumer would enable the editor and rights holders, including the software developer, to achieve revenues.

Optionally, fees (pricing) and permissions (dissemination) may be set to null; that is, prices may be set to zero and all software adoption conditions lifted.

The present invention contemplates implementation by providing a social networking and content building utility, which may be referred to as an “open builder”. The open builder enables editors/compilers to provide an environment where they create a learning outline (such as a course or seminar outline), and then disseminate such outline, including for example by means of a social network utility linked to the present invention. The web space defined for or linked to such outlines may incorporate or be linked to other common social networking functions such as rating, ranking, and messaging regarding outlines or content (including specific compilations). Messaging may include for example the ability to suggest related content (such as similar, better or contrary content), and also discussions regarding content. It should be understood that this social networking functionality described may be built around the present invention to optionally use the technology to create compilations as described. Others in the social network can build compilations based on those created by specific users or in fact find and use the very same compilations as those created by other users of the present technology, thereby enabling the dissemination of the technology as well as expansion of the market for specific content, based on the rights management and monetization of the content in an efficient manner, as described.

It should be understood that the present invention may be integrated with or linked to learning management systems (LMS).

### Revenue Models

As previously described, each of the rights holder, editor, and administrator may attach pricing conditions to content elements or liquid works. The present invention provides a plurality of revenue models to enable these parties to optimize revenues.

In one aspect of the present invention, consumers may pay for access to liquid works created by an intermediary (such as an editor). The proceeds may be divided between participating rights holders, who may receive their wholesale price times units sold. The administrator may receive the mark-up it places on content used in the liquid work, times units sold.

In a second aspect of the present invention, the system and method is licensed to individual rights holders, who pay the administrator either or both of a licensing fee and a percentage of sales. Enabling this aspect of the present invention does not preclude a rights holder from contributing content under the first aspect of the present invention, or vice versa. When contrasted to alternative solutions, the system and method of the present invention offer more choice to rights holders about how to commercialize their content.

It should be understood that the present invention also contemplates the use of advertising related revenue models to monetize the present invention or the content described. Data referred to above such as content related metrics may be monetized for example by charging publishers a subscription fee or per resport fee for the results of reporting or analytics utilities linked to the present invention.

1. A method for disseminating content characterized in that it comprises:
a. one or more rights holders providing one or more items of content to a database linked to one or more computers;
b. the rights holders directing parsing of the content into content elements by operation of the one or more computers or one or more associated computers;
c. the rights holders associating pricing conditions and dissemination conditions with the content by operation of the one or more computers or one or more associated computers;
d. one or more editors assembling the content elements into one or more compilations by operation of the one or more computers or one or more associated computers; and
e. one or more consumers purchasing one or more of the compilations by operation of the one or more computers or one or more associated computers.

2. The method of claim 1, characterized in that it comprises the further step of the editors contributing content and annotations in the compilations.

3. The method of claim 1, characterized in that the one or more compilations are updated if the rights holders provide new content, updating previously provided content.

4. The method of claim 1, characterized in that the one or more editors collaborate to create the one or more compilations.

5. The method of claim 1, characterized in that the one or more consumers locate a second compilation by accessing a content element in a first compilation, the content element also being assembled into the second compilation, and the one or more consumers being provided with a link to the second compilation.

6. The method of claim 5, characterized in that the second compilation is the content.

7. The method of claim 6, characterized in that the link is a bibliographic citation embedded in the content element.

8. The method of claim 1, characterized in that the one or more editors are rights holders of the one or more compilations, each compilation including one or more items of content.

9. The method of claim 1, characterized in that the method comprises the further steps of:
a. tracking purchases of the one or more compilations by the one or more consumers;
b. reporting the purchases to the editors and to the rights holders;
c. the rights holders determining the pricing conditions and the dissemination conditions to increase the purchases;
d. an administrator adding a mark-up price to the pricing conditions; and
e. the editors determining which of the one or more content elements to assemble into the compilations based on the pricing conditions, the dissemination conditions, and the mark-up price.

10. A system for disseminating content comprising:
a. a database linked to one or more computers, operable to store one or more items of content provided by one or more rights holders;
b. one or more computer implemented utilities for enabling one or more of:
i. parsing the content into content elements as specified by the rights holders;
ii. associating pricing conditions and dissemination conditions with each content element;
iii. assembling compilations of the content elements by editors; and
iv. providing the content elements to consumers.

11. The system of claim 10 characterized in that the system enables the editors to contribute content and annotations in the compilations.

12. The system of claim 10 characterized in that the one or more compilations are updated if the rights holders provide new content updating previously provided content.

13. The system of claim 10 characterized in that the one or more editors collaborate to create the one or more compilations.

14. The system of claim 10, characterized in that the system enables the one or more consumers to locate a second compilation by accessing content elements in a first compilation, the content elements also being assembled into the second compilation, and the one or more consumers being provided with a link to the second compilation.

15. The system of claim 10, characterized in that the system further comprises or is linked to:
a. a computer implemented utility for tracking purchases of the one or more compilations by the one or more consumers; and
b. a computer implemented utility for enabling one or more of (i) reporting the purchases to the editors and to the rights holders; (ii) pricing conditions and the dissemination conditions determined by the rights holders to increase the purchases; (iii) a mark-up price to be added to the pricing conditions by an administrator; and (iv) editors determining which of the one or more content elements to assemble into the compilations based on the pricing conditions, the dissemination conditions, and the mark-up price.

16. A computer program product for disseminating content, the product comprising a computer readable medium bearing software instructions, characterized in that the software instructions are operable to enable one or more computers to perform predetermined operations, the predetermined operations including the steps of:
i. one or more rights holders providing content to a database;
ii. the rights holders directing parsing of the content into content elements;
iii. the rights holders setting dissemination and pricing conditions;
iv. one or more editors assembling content elements into one or more compilations; and
v. one or more consumers purchasing one or more of the compilations.

17. The computer program product of claim 16, characterized in that the one or more editors are rights holders of the one or more compilations, each compilation including one or more items of content.

18. The computer program product of claim 16, characterized in that the predetermined operations further include one or more of:
a. tracking purchases of the one or more compilations by the one or more consumers;
b. reporting the purchases to the editors and to the rights holders;
c. the rights holders determining the pricing conditions and the dissemination conditions to increase the purchases;
d. an administrator adding a mark-up price to the pricing conditions; and
e. the editors determining which of the one or more content elements to assemble into the compilations based on the pricing conditions, the dissemination conditions, and the mark-up price.
